(19) United States
(12) Patent Application Publication
(10) Pub. No.: US 2006/0291138 A1
(43) Pub. Date: Dec. 28, 2006

(54) Built-in type upper/lower electrode multi-layer part and method of manufacturing thereof

(75) Inventors: Sung Hyung Kang, Suwon (KR); Jin Yong Ahn, Daejeon (KR); Suk Hyeon Cho, Daejeon (KR); Young Don Choi, Suwon (KR); Hae Suk Chung, Seoul (KR); Chang Hoon Shim, Yongin (KR)

Correspondence Address: MCDERMOTT WILL & EMERY LLP, 600 13TH STREET, N.W., WASHINGTON, DC, 20005-3096, US

(73) Assignee: SAMSUNG Electro-Mechanics Co., Ltd.

(21) Appl. No.: 11/472,335

(22) Filed: Jun. 22, 2006

(30) Foreign Application Priority Data
Jun. 22, 2005 (KR) 10-2005-0053844

(51) Int. Cl. H01G 4/236

(52) U.S. Cl. 361/307

(57) ABSTRACT

The present invention relates to a method of manufacturing a built-in type upper/lower electrode multi-layer part including alternately laminating a first ceramic sheet having a first internal electrode pattern formed thereon and a second ceramic sheet having a second internal electrode pattern formed thereon so as to form a first multi-layer sheet product; forming first and second via holes on the first multi-layer sheet product, the first and second via holes respectively connecting the first and second internal electrode patterns; respectively joining third and fourth ceramic sheets having no internal electrode pattern on the upper and lower portions of the first multi-layer sheet product so as to form a second multi-layer sheet product, the third and fourth ceramic sheets having third and fourth via holes formed to correspond to the first and second via holes; and filling a conductive paste in the first to fourth via holes.

### CROSS-REFERENCE TO RELATED APPLICATIONS

The application claims the benefit of Korea Patent Application No. 2005-0053844 filed with the Korea Industrial Property Office on Jun. 22, 2005, the disclosure of which is incorporated herein by reference.

### BACKGROUND OF THE INVENTION

1. Field of the Invention

The present invention relates to a built-in type upper/lower electrode multi-layer part and a method of manufacturing the same, and more specifically, to a built-in type upper/lower electrode multi-layer part, in which an area where internal electrode patterns of a plurality of laminated ceramic sheets overlap each other is formed to differ according to an electrostatic capacity so as to realize a desired band of electrostatic capacity, and a method of manufacturing the same.

Further, the present invention relates to a built-in type upper/lower electrode multi-layer part, in which upper and lower external electrodes can be formed by only via holes without any nickel (Ni) layer being formed on a ceramic sheet, and a method of manufacturing the same.

Furthermore, the present invention relates to a built-in type upper/lower electrode multi-layer part, in which external electrodes thereof are formed on the overall portion or a predetermined portion of the upper and lower surfaces and the part is formed to have the same length and width as each other so that via holes are easily formed on a substrate, the number of punching or drilling processes through which the part is built into the substrate can be reduced to one time, and the bending strength of the part can be enhanced, and a method of manufacturing the same.

2. Description of the Related Art

Recently, the integration of design and the miniaturization of parts are being achieved for the sake of creating a lighter, slimmer, more compact electronic products. However, such integration and miniaturization are followed by various difficulties in process elements and characteristics. Therefore, in order to solve the problems, parts which have been mounted on a substrate in the related art tend to be built into a substrate. In this case, the thickness of the part should be smaller than that of the substrate so that the part can be built into the substrate, which makes it difficult to form an external electrode of the part. Now, a method of forming an external electrode according to the related art will be examined with reference to the drawings, and the problems thereof will be described.

FIG. 1 is a perspective view illustrating a built-in type left/right electrode multi-layer part according to the related art, showing a multi-layer ceramic capacitor (MLCC) as an example. FIG. 2 is a cross-sectional view taken along A-A line of FIG. 1.

As shown in FIGS. 1 and 2, the built-in type left/right electrode multi-layer part 4 according to the related art has external electrodes 3 formed to cover both ends of a cubical main body 1. The main body 1 is formed as follows. Dielectric ceramic sheets on which an internal electrode pattern 2 is printed are laminated so as to form a multi-layer sheet product. The multi-layer sheet product is properly cut into the main body 1. The cutting allows one end of the internal electrode pattern 2 to be exposed outside on both ends of the main body 1.

The external electrodes 3 cover the outside of both ends of the main body 1, and are connected to the internal electrode pattern 2 which is exposed outside of the cubical main body 1 by cutting the multi-layer sheet product. In other words, since the internal electrode pattern 2 is selectively exposed on both ends of the main body 1, both ends of the main body 1 are dipped into a metallic paste, and the external electrodes 3 are adhered to both ends thereof. After that, the external electrodes 3 are burned through an electrode burning process. Finally, a nickel (Ni) layer or SnPb layer (or Sn layer) is plated on the surface of the external electrodes 3 so as to completely manufacture a chip element.

The external electrode 3 can be formed by a sputtering method, paste baking method, vapor deposition method, and plating method, which are well-known, in addition to the above-described dipping method.

Among them, the dipping method is widely used to form an external electrode. In the dipping method as described above, a multi-layer ceramic capacitor (MLCC) forming the external electrode is attached to a jig, and a conductive (for example, Cu) paste is applied on a portion, in which the external electrode is formed, so as to be heated. Then, nickel (Ni) and tin (Sn)-lead (Pb) are sequentially plated thereon to completely manufacture the external electrode.

FIGS. 3A and 3B are reference diagrams for explaining the problems of the built-in type left/right electrode multi-layer part according to the related art.

In the built-in type left/right electrode multi-layer part according to the related art, the electrodes are formed only in the left and right directions, and the length and width of the part are different from each other, as shown in FIG. 3A.

Therefore, since the built-in type left/right electrode multi-layer part of which the length and width are different from each other should be punched and drilled so as to be built into a substrate, the punching or drilling needs to be performed at least more than two times.

Since the length and width of the built-in type left/right electrode multi-layer part according to the related art are different from each other, the part is likely to be bent when a load is applied vertically.

In the built-in type left/right electrode multi-layer part according to the related art, when the substrate is drilled to form a via hole for electrical connection, the precision as much as the width of the band of the external electrode should be secured so that the part is not opened, which makes it very difficult to form the via hole. Furthermore, when a small-sized part is manufactured, a high-precision punching or drilling technique is required, which makes it harder to manufacture the part.

In the built-in type left/right electrode multi-layer part according to the related art, when the left/right external electrodes of a thin part (for example, a part having a thickness of less than 0.8 mm) are formed by a dipping method, a small amount of paste for forming an external electrode is applied on the left and right portions of the part, and a large amount of paste is applied on the upper and lower portions of the part, as shown in FIG. 3B, which means the part is formed in a matchstick shape. As such, if the left and right external electrodes are formed in a matchstick shape, the problems are caused in the connection with the internal electrode, and it is possible to manufacture a part having a desired thickness.

### SUMMARY OF THE INVENTION

An advantage of the present invention is that it provides a built-in type upper/lower electrode multi-layer part, in which an area where internal electrode patterns of a plurality of laminated ceramic sheets overlap each other is formed to differ according to an electrostatic capacity so as to realize a desired band of electrostatic capacity, and a method of manufacturing the same.

Another advantage of the invention is that it provides a built-in type upper/lower electrode multi-layer part, in which a plurality of first and second ceramic sheets having a different internal electrode pattern from each other are alternately laminated so as to form a multi-layer sheet product, first and second via holes for respectively connecting the first and second ceramic sheets are formed, and via holes which are formed on ceramic sheets joined on the top and bottom surfaces of the multi-layer sheet product are formed to be larger than the first and second via holes, so that upper and lower external electrodes can be formed by only via holes without nickel layers being formed, and a method of manufacturing the same.

A further advantage of the invention is that it provides a built-in type upper/lower electrode multi-layer part, in which the external electrodes of the part are formed on the entire upper and lower portions or predetermined upper and lower portions so that the via holes are easily formed on a substrate, and a method of manufacturing the same.

A still further advantage of the invention is that it provides a built-in type upper/lower electrode multi-layer part, which is manufactured to have the same width and length as each other so that the number of punching and drilling processes for building the part into the substrate can be reduced to one time and the bending strength of the part can be enhanced.

Additional aspects and advantages of the present general inventive concept will be set forth in part in the description which follows and, in part, will be obvious from the description, or may be learned by practice of the general inventive concept.

According to an aspect of the invention, a method of manufacturing a built-in type upper/lower electrode multi-layer part includes alternately laminating a first ceramic sheet having a first internal electrode pattern formed thereon and a second ceramic sheet having a second internal electrode pattern formed thereon so as to form a first multi-layer sheet product; forming first and second via holes on the first multi-layer sheet product, the first and second via holes respectively connecting the first and second internal electrode patterns; respectively joining third and fourth ceramic sheets having no internal electrode pattern on the upper and lower portions of the first multi-layer sheet product so as to form a second multi-layer sheet product, the third and fourth ceramic sheets having third and fourth via holes formed to correspond to the first and second via holes; and filling a conductive paste in the first to fourth via holes.

The first and second ceramic sheets are formed in a square shape.

Predetermined portions of the first and second internal electrode patterns overlap each other when the first and second ceramic sheets are laminated.

An area where the first and second internal electrode patterns overlap each other differs in accordance with an electrostatic capacity.

The size of the third and fourth via holes is the same as that of the first and second via holes.

Further, the size of the third and fourth via holes is larger than that of the first and second via holes.

According to another aspect of the invention, the method of manufacturing a built-in type upper/lower electrode multi-layer part further respectively forming metal layers on the upper and lower portions of the second multi-layer sheet product in which the conductive paste is filled.

The metal layers are formed by joining metallic sheets.

The metal layers are formed at the same time when a conductive paste is filled in the first to fourth via holes.

The metal layer is formed of nickel (Ni).

The metal layer is plated so as not to be oxidized by water.

According to a further aspect of the invention, a built-in type upper/lower electrode multi-layer part includes a first ceramic sheet having a first internal electrode pattern formed thereon; a second ceramic sheet having a second internal electrode pattern formed thereon; a first multi-layer sheet product which is formed by alternately laminating the first and second ceramic sheets and in which first and second via holes are formed to respectively connect the first and second internal electrode patterns; a second multi-layer sheet product in which third and fourth ceramic sheets having no internal electrode pattern are respectively joined on the upper and lower portions of the first multi-layer sheet product, the third and fourth ceramic sheets having third and fourth via holes formed to correspond to the first and second via holes; and a conductive paste which is filled in the first to fourth via holes.

The first and second ceramic sheets are formed in a square shape.

Predetermined portions of the first and second internal electrode patterns overlap each other when the first and second ceramic sheets are laminated.

The first internal electrode pattern is formed in a reverse L shape, and the second internal electrode pattern is formed in an L shape.

The first internal electrode pattern having a first hole formed on one side thereof is formed in a square shape, and the second internal electrode pattern having a second hole formed on one side thereof is formed in a square shape.

The first internal electrode pattern is formed in a reverse L shape or an L shape, and a predetermined portion of the second internal electrode pattern is overlapped with the first internal electrode pattern so as to realize a low capacity band.

The first internal electrode pattern having a first hole formed on one side thereof is formed in a square shape, and the second internal electrode pattern having a second hole formed on one side thereof is formed so that the overall internal electrode pattern is included in the first internal electrode pattern.

The third and fourth via holes have the same size as the first and second via holes.

Further, the third and fourth via holes have a larger size than the first and second via holes.

According to a still further aspect of the invention, the built-in type upper/lower electrode multi-layer further includes metal layers that are formed on the upper and lower portions of the second multi-layer sheet product in which the conductive paste is filled.

The metal layers are formed of a metallic sheet.

The metal layers are formed at the same time when the conductive paste is filled in the first to fourth via holes.

The metal layers are plated so as not to be oxidized by water.

The built-in type upper/lower electrode multi-layer part is manufactured by a method according to any one of the above aspects.

Since the area where the internal electrode patterns of the plurality of laminated ceramic sheets overlap each other is formed to differ according to an electrostatic capacity, a desired band of electrostatic capacity can be realized.

Without nickel layers being formed, the upper and lower external electrodes can be formed.

In addition, when the part is built into a substrate, the via holes are easily formed in a substrate. Further, the number of punching or drilling processes for building the part into the substrate can be reduced to one time, and the bending strength of the part can be enhanced.

FIGS. 4 to 7 show the built-in type upper/lower electrode multi-layer part in which the area where the internal electrode patterns of the plurality of laminated ceramic sheets overlap each other is formed to differ according to an electrostatic capacity, so that a desired band of electrostatic capacity can be realized.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a built-in type left/right electrode multi-layer part according to the related art;

FIG. 2 is a cross-sectional view taken along A-A line of FIG. 1;

FIGS. 3A and 3B are reference diagrams for explaining the problems of the built-in type left/right electrode multi-layer part according to the related art;

FIGS. 4A to 4G are diagrams explaining a process of manufacturing a built-in type upper/lower electrode multi-layer part according to a first embodiment of the present invention;

FIGS. 5A to 5G are diagrams explaining a process of manufacturing a built-in type upper/lower electrode multi-layer part according to a second embodiment of the invention;

FIGS. 6A and 6B are diagrams explaining a process of manufacturing a built-in type upper/lower electrode multi-layer part according to a third embodiment of the invention;

FIGS. 7A and 7B are diagrams explaining a process of manufacturing a built-in type upper/lower electrode multi-layer part according to a fourth embodiment of the invention;

FIG. 8 is a diagram explaining a process of manufacturing a built-in type upper/lower electrode multi-layer part according to a fifth embodiment of the invention;

FIG. 9 is a diagram explaining a process of manufacturing a built-in type upper/lower electrode multi-layer part according to a sixth embodiment of the invention;

FIG. 10 is a diagram explaining a process of manufacturing a built-in type upper/lower electrode multi-layer part according to a seventh embodiment of the invention.

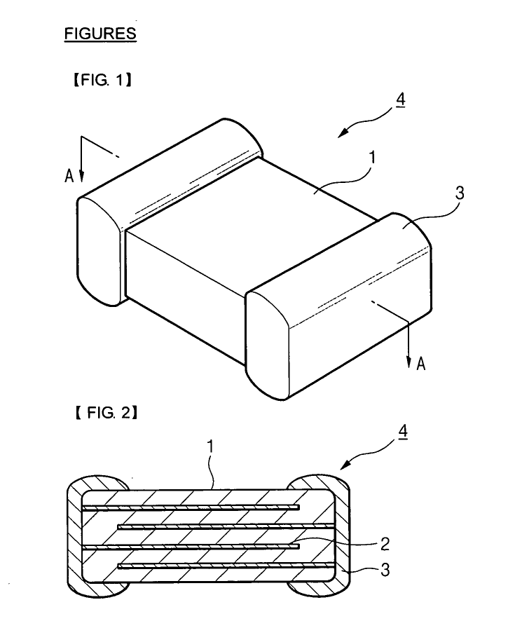

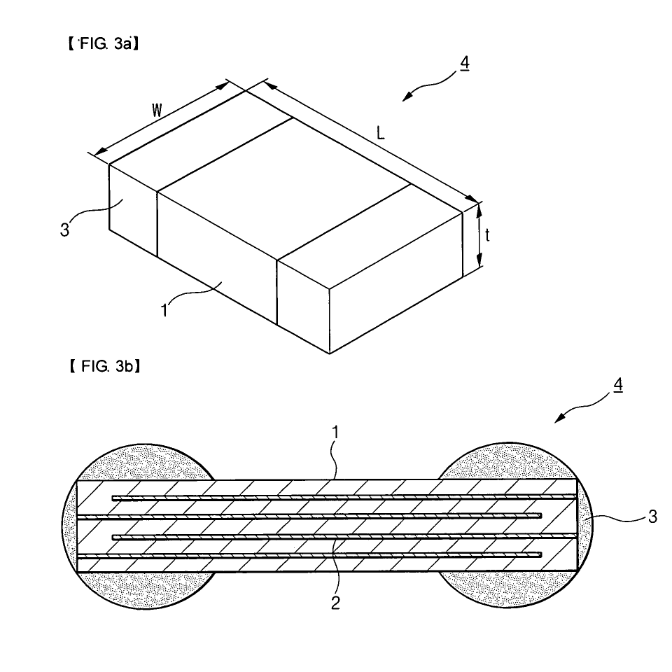

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, preferred embodiments of the present invention will be described in detail with reference to the accompanying drawings.

[First Embodiment]

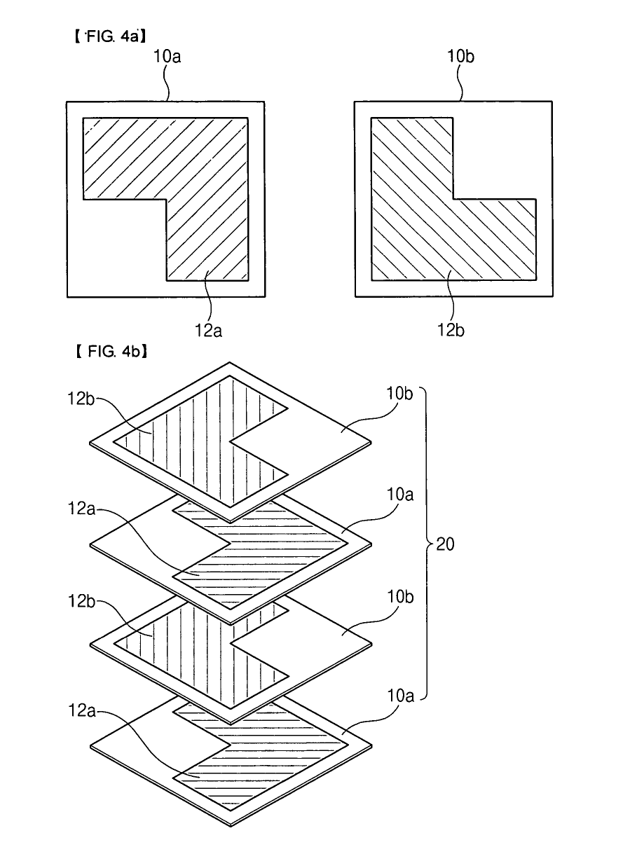

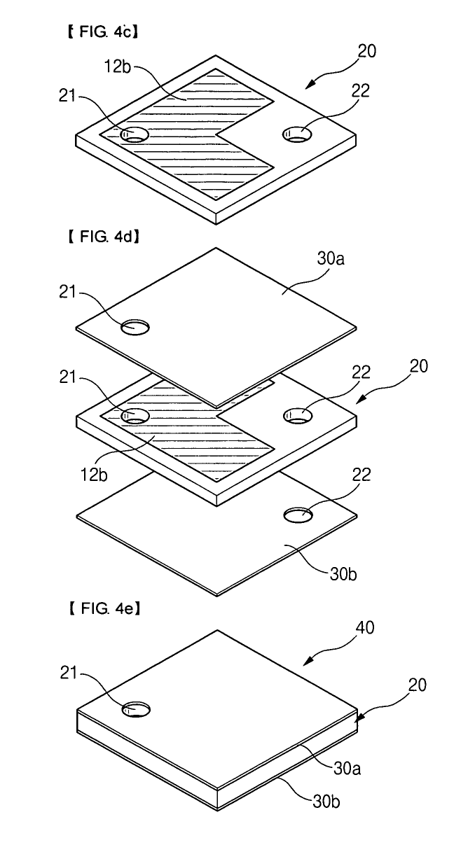

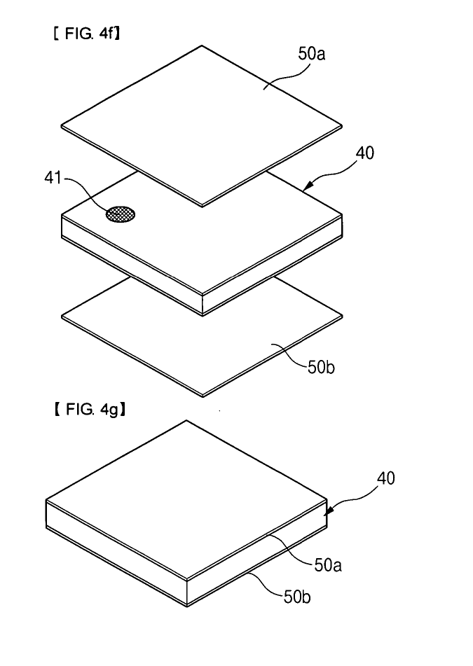

FIGS. 4A to 4G are diagrams explaining a process of manufacturing a built-in type upper/lower electrode multi-layer part according to a first embodiment of the present invention, and the procedure of the process is as follows.

Referring to FIG. 4A, a first internal electrode pattern 12a having a predetermined shape is formed on one side of a first ceramic sheet 10a, and a second internal electrode pattern 12b is formed on one side of a second ceramic sheet 10b. When the first and second ceramic sheets 10a and 10b are overlapped with each other, a portion of the first internal electrode pattern 10a overlaps a portion of the second internal electrode pattern 10b.

At this time, the first and second ceramic sheets 10a and 10b are formed in a square shape where the length and width are the same as each other. As shown in FIG. 4A, the first internal electrode pattern 12a is formed in a reverse L shape, and the second internal electrode pattern 12b is formed in an L shape.

The shape of the first and second internal electrode patterns 12a and 12b can be formed to differ according to an electrostatic capacity.

The electrostatic capacity of the first and second ceramic sheets 10a and 10b can be expressed by the following equation 1.

$$C = \frac{Q}{S} = {ɛ}_{o} {ɛ}_{r} \frac{nS}{t} \qquad [ Equation 1 ]$$

Here, S represents an area where the first and second inner electrodes patterns 12a and 12b overlap each other, εₒ, represents a relative dielectric constant of a material between the first and second internal electrode patterns 12a and 12b, εᵣ represents a proportional constant, Q represents an electric charge, n represents the number of the first and second ceramic sheets 10a and 10b, and t represents the thickness of the first and second ceramic sheets 10a and 10b.

In order to increase the electrostatic capacity C from the equation 1, the area S where the first and second internal electrode patterns 12a and 12b overlap each other can be enlarged, a material having a large relative dielectric constant can be used between the first and second ceramic sheets 10a and 10b, or the distance between the first and second ceramic sheets 10a and 10b can be reduced.

Therefore, if the area where the first and second internal electrode patterns 12a and 12b overlap each other is enlarged, the electrostatic capacity C increases. On the other hand, if the area where the first and second internal electrode patterns 12a and 12b overlap each other is reduced, the electrostatic capacity C decreases.

In the present invention, the area where the first and second internal electrode patterns 12a and 12b overlap each other is formed to differ in order to realize a desired electrostatic capacity C. Accordingly, the first and second internal electrode patterns 12a and 12b can be implemented to have a different shape from the shape which has been implemented in the first embodiment.

Next, as shown in FIG. 4B, the plurality of first and second ceramic sheets 10a and 10b are alternately laminated so as to form a first multi-layer product 20.

On the first multi-layer product 20, a first via hole 22 is formed so as to connect the first internal electrode pattern 12a formed in the first ceramic sheet 10a, and a second via hole 21 is formed so as to connect the second internal electrode pattern 12b formed in the second ceramic sheet 10b, as shown in FIG. 4C.

As shown in FIG. 4D, another second via hole 21 having the same size and position as the above-described second via hole 21 is formed on a third ceramic sheet 30a, and another via hole 22 having the same size and position as the above-described first via hole 22 is formed on a fourth ceramic sheet 30b. The third and fourth ceramic sheets 30a and 30b do not have an internal electrode pattern formed thereon.

As shown in FIG. 4D and 4E, the plurality of third and fourth ceramic sheets 30a and 30b are laminated to have a desired thickness on the upper and lower portions of the first multi-layer sheet product 20, respectively.

FIG. 4E illustrates a second multi-layer sheet product 40 in which the third and fourth ceramic sheets 30aand 30b are joined on the upper and lower portions of the first multi-layer sheet product 20. On the top surface of the second multi-layer product 40, the via hole 21 is formed so as to connect the second internal electrode pattern 12b. On the bottom surface of the second multi-layer product 40, the first via hole 22 is formed so as to connect the first internal electrode pattern 12b.

As shown in FIG. 4F, a conductive paste 41 is filled in the first and second via holes 22 and 21 formed on the second multi-layer product 40 and is then dried.

By the paste 41 filled in the first and second via hole 22 and 21, the first internal electrode patterns 12a of the first ceramic sheets 10a are electrically connected to each other, and the second internal electrode patterns 12b of the second ceramic sheets 10bare electrically connected to each other.

As shown in FIGS. 4F and 4G, nickel (Ni) layers 50a and 50b are respectively formed on the upper and lower portions of the second multi-layer sheet product 40 in which the paste 41 is filled.

The nickel layers 50a and 50b can be formed by any one of the following two methods. The first is where the nickel layers 50a and 50b are formed in a sheet type so as to be joined, as shown in FIG. 4F. The second is where the nickel layers 50a and 50b are formed at the same time when the paste 41 is filled in the first and second via holes 22 and 21, as shown in FIG. 4G. In the latter, nickel is used as the paste 41 so that the first and second via holes 22 and 21 and the nickel layers 50a and 50b are formed at the same time.

When the nickel layers 50a and 50b are formed, the nickel layers 50a and 50b can be plated so as not to be oxidized by water.

Finally, after grinding, a chip having a desired shape is completely manufactured through a plasticizing and burning process.

After that, the chip is separated into a unit of chip by any one of blade-cutting, laser-cutting, and dicing.

[Second Embodiment]

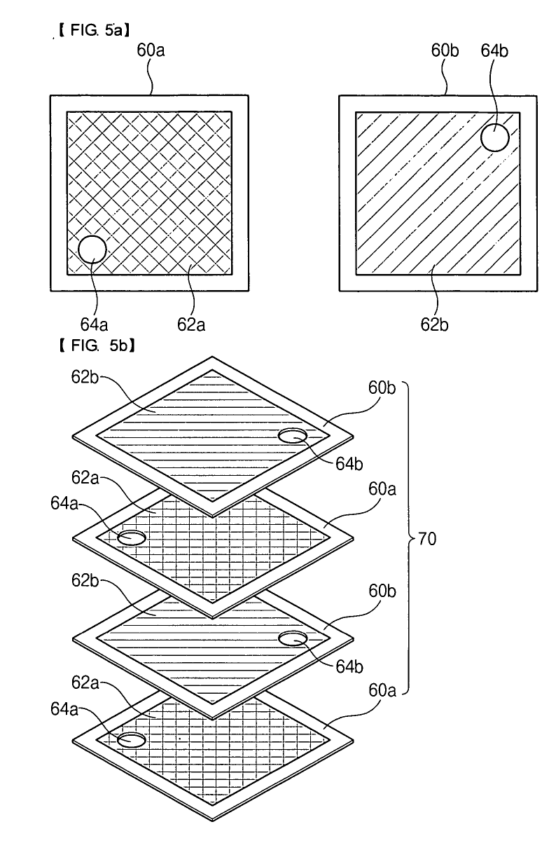

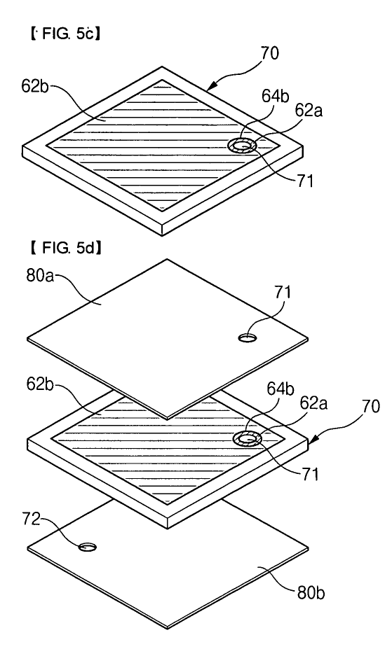

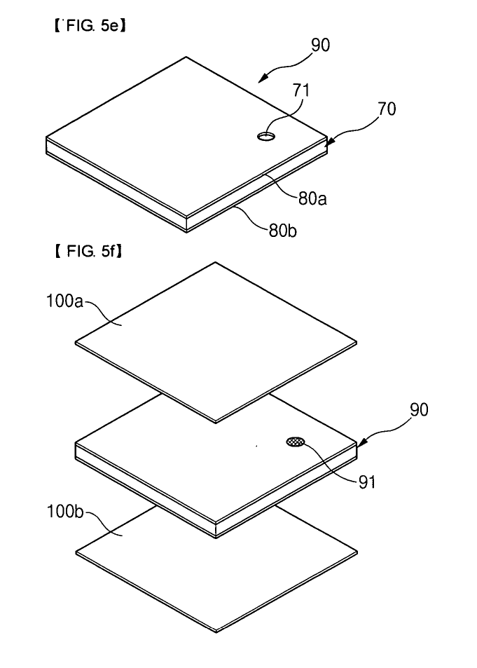

FIGS. 5A to 5G are diagrams explaining a process of manufacturing a built-in type upper/lower electrode multi-layer part according to a second embodiment of the present invention, in which internal electrode patterns are implemented to have a different shape so that an area where internal electrode patterns overlap each other is different from that of the first embodiment.

As shown in FIG. 5A, the built-in type upper/lower electrode multi-layer part is formed so that a first internal electrode pattern 62a having a predetermined shape is formed on one side of a first ceramic sheet 60a and a second internal electrode pattern 62b is formed on one side of a second ceramic sheet 60b. When the first and second ceramic sheets 60a and 60b are overlapped with each other, a portion of the first electrode pattern 62a overlaps a portion of the second electrode pattern 62b.

The first and second ceramic sheets 60a and 60b are formed in a square shape where the width and length are the same, as in the first embodiment. As shown in FIG. 5A, the first internal electrode pattern 62a having a first hole 64a formed in one corner thereof is formed in a square shape. The second internal electrode pattern 62b having a second hole 64b formed in a corner thereof is formed in a square shape. The first and second holes 64a and 64b are positioned in a diagonal direction when the first and second ceramic sheets are laminated.

As shown in FIG. 5B, the plurality of first and second ceramic sheets 60a and 60b are alternately laminated so as to form a first multi-layer sheet product 70.

On the first multi-layer sheet product 70, a first via hole 71 for connecting the first internal electrode pattern 62a of the first ceramic sheet 60a is formed inside the second hole 64b, and a second via hole 72 for connecting the second internal electrode pattern 62b of the second ceramic sheet 60b is formed inside the first hole 64a, as shown in FIG. 5C. In order to prevent the first and second internal electrode patterns 62a and 62b from being short-circuited, the size of the first via hole 71 is smaller than that of the second hole 64b, and the size of the second via hole 72 is also smaller than that of the first hole 64a.

As shown in FIG. 5D, another first via hole 71 having the same size and position as the above-described first via hole 71 is formed on a third ceramic sheet 80a, and another second via hole 72 having the same size and position as the above-described second via hole 72 is formed on a fourth ceramic sheet 80b. The third and fourth ceramic sheets 80a and 80b do not have an internal electrode pattern formed thereon.

As shown in FIGS. 5D and 5E, the plurality of third and fourth ceramic sheets 80a and 80b are laminated to have a desired thickness on the upper and lower portions of the first multi-layer sheet product 70, respectively.

FIG. 5E illustrates a second multi-layer sheet product 90 in which the third and fourth ceramic sheet 80a and 80b are respectively joined on the upper and lower portions of the first multi-layer sheet product 70. The first via hole 71 for connecting the first internal electrode pattern 62a is formed on one side of the second multi-layer sheet product 90, and the second via hole for connecting the second internal electrode pattern 62b is formed on the other side of the second multi-layer sheet product 90.

As shown in FIG. 5F, a conductive paste 91 is filled in the first and second via holes 17 and 72 which are respectively formed on one side and the other side of the second multi-layer sheet product 90, and is then dried.

By the paste 91 filled in the first and second via holes 17 and 72, the first internal electrode patterns 62a formed in the first ceramic sheets 60a are electrically connected to each other, and the second internal electrode patterns 62b formed in the second ceramic sheets 60b are electrically connected to each other.

As shown in FIGS. 5F and 5G, nickel (Ni) layers 100a and 100b are respectively formed on the upper and lower portions of the second multi-layer sheet product 90 in which the paste 91 is filled.

The nickel layers 100a and 100b can be formed by any one of the following two methods. The first is where the nickel layers 100a and 100b are formed in a sheet type so as to be joined, as shown in FIG. 5F. The second is where the nickel layers 100a and 100b are formed at the same time when the paste 91 is filled in the first and second via holes 17 and 72, as shown in FIG. 5G. In the latter, nickel is used as the paste 91 so that the first and second via holes 17 and 72 and the nickel layers 100a and 100b are formed at the same time.

When the nickel layers 100a and 100b are formed, the nickel layers 100a and 100b can be plated so as not to be oxidized by water.

Finally, after grinding, a chip having a desired shape is completely manufactured through a plasticizing process and burning process, and is then separated into a unit of chip.

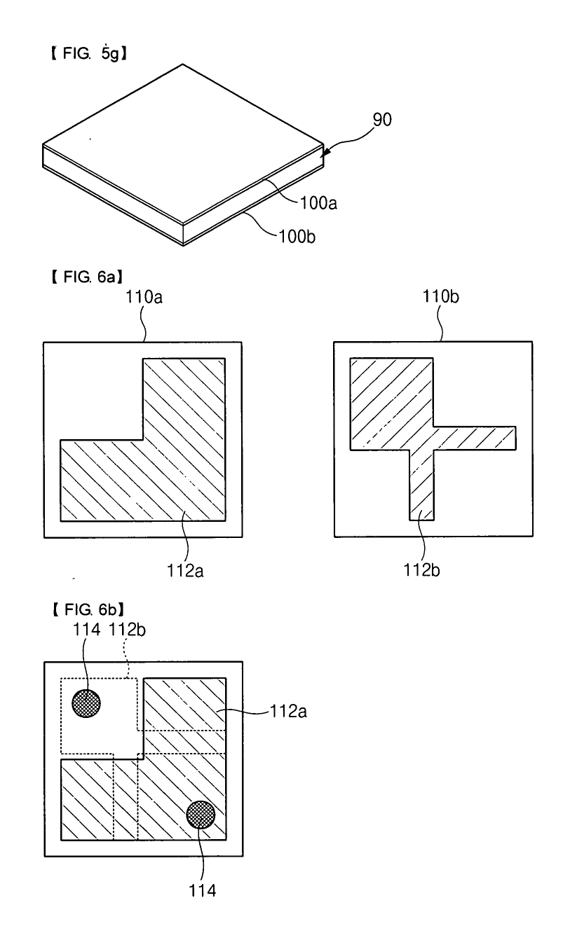

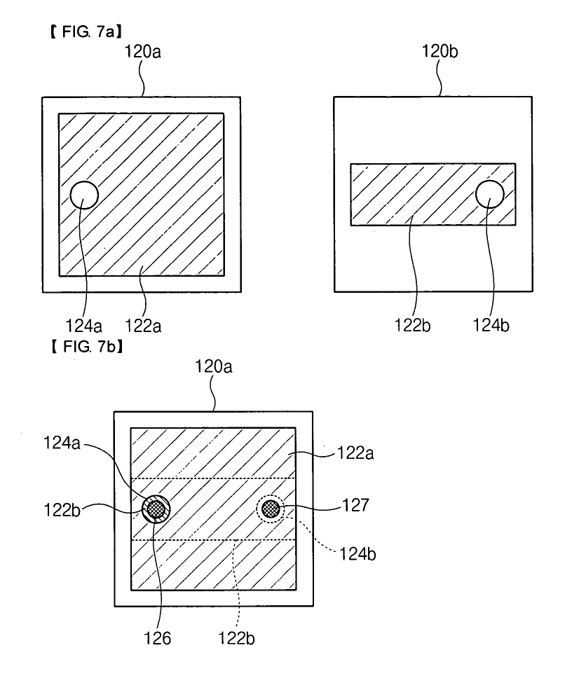

Next, a method of manufacturing a built-in type upper/lower electrode multi-layer part with a low capacity band will be described with reference to FIGS. 6 and 7.

[Third Embodiment]

FIGS. 6A and 6B are diagrams explaining a process of manufacturing a built-in type upper/lower electrode multi-layer part according to a third embodiment of the present invention.

In the built-in type upper/lower electrode multi-layer part according to the third embodiment, an area where internal electrode patterns overlap each other when ceramic sheets are laminated is reduced to realize a low capacity band. The built-in type upper/lower electrode multi-layer part is manufactured almost the same as those of the first and second embodiments.

As described above, an electrostatic capacity differs according to an area where the internal electrode patterns overlap each other. Therefore, if the area where the internal electrode patterns overlap each other is reduced, a low capacity band can be realized.

The internal electrode patterns of the built-in type upper/lower electrode multi-layer part according to the third embodiment are formed as follows. As shown in FIG. 6A, a first internal electrode pattern 112a having a predetermined shape is formed on one side of a first ceramic sheet 110a, and a second internal electrode pattern 112b is formed on one side of a second ceramic sheet 110b so as to overlap a predetermined portion of the first internal electrode pattern 112a when the first and second ceramic sheets 110aand 110b are laminated.

For example, the first internal electrode pattern 112a is formed in a reverse L shape (or an L shape), as shown in FIG. 6A. The second internal electrode pattern 112b is formed to overlap a portion of the first internal electrode pattern 112a so that a low capacity band can be realized.

The first and second ceramic sheets 110a and 110b in which the first and second internal electrode patterns 112a and 112b are respectively formed are alternately laminated so as to form a multi-layer sheet product, as in FIG. 4B (or FIG. 5B).

Subsequently, a first via hole (not shown) is formed on the first internal electrode pattern 112a so that the first internal electrode patterns 112a of the multi-layer sheet product are connected to each other, and a second via hole (not shown) is formed on the second internal electrode pattern 112b so that the second internal electrode patterns 112b are connected to each other.

After the ceramic sheets in which the first and second via holes are formed are joined to each other to form a multi-layer sheet product, a conductive paste 114 is filled in the first and second via holes.

Finally, as in FIGS. 4F and 4G (or FIGS. 5F and 5G), nickel (Ni) layers are respectively formed on the upper and lower portions of the multi-layer sheet product. Then, a chip having a desired shape is completely manufactured through a grinding process and a plasticizing and burning process.

[Fourth Embodiment]

FIGS. 7A and 7B are diagrams explaining a process of manufacturing a built-in type upper/lower electrode multi-layer part according to a fourth embodiment of the present invention.

In the built-in type upper/lower electrode multi-layer part according to the fourth embodiment, internal electrode patterns are formed to have a different shape in order to realize a low capacity band, as in FIG. 6.

The built-in type upper/lower electrode multi-layer part is formed as follows. As shown in FIG. 7A, a first internal electrode pattern 122a having a first hole 124a formed in one side is formed on a first ceramic sheet 120a, and a second internal electrode pattern 122b having a second hole 124b formed in one side is formed on a second ceramic sheet 120b. The first hole 124a is positioned in the opposite side to the second hole 124b when the first and second ceramic sheets 120a and 120b are laminated. The second internal electrode pattern 122b is formed to be small enough that the overall second internal electrode pattern 122b is overlapped with the first internal electrode pattern 122a.

For example, the first internal electrode pattern 122a having the first hole 124a is formed in a square shape, as shown in FIG. 7A, and the second internal electrode pattern 122b having the second hole 124b is formed to be small enough that the overall second internal electrode pattern 122b is included in the first internal electrode pattern 122a.

Similarly, the first and second ceramic sheets 120a and 120b in which the first and second internal electrode patterns 122a and 122b are formed are alternately laminated so as to form a multi-layer sheet product, as in FIG. 4B (or FIG. 5B).

Inside the second hole 124b, a first via hole (not shown) is formed so that the multi-layer first internal electrode patterns 122a are connected to each other. Inside the first hole 124a, a second via hole (not shown) is formed so that the second internal electrode patterns 122b are connected to each other.

After the ceramic sheets in which the first and second via holes are formed are joined on the upper and lower portions of the multi-layer sheet product, a conductive paste 127 is filled in the first and second via holes.

Finally, as in FIGS. 4F and 4G (or FIGS. 5F and 5G), nickel (Ni) layers are formed on the upper and lower portions of the multi-layer sheet product, and then a chip having a desired shape is completely manufactured through a grinding process and a burning and plasticizing process.

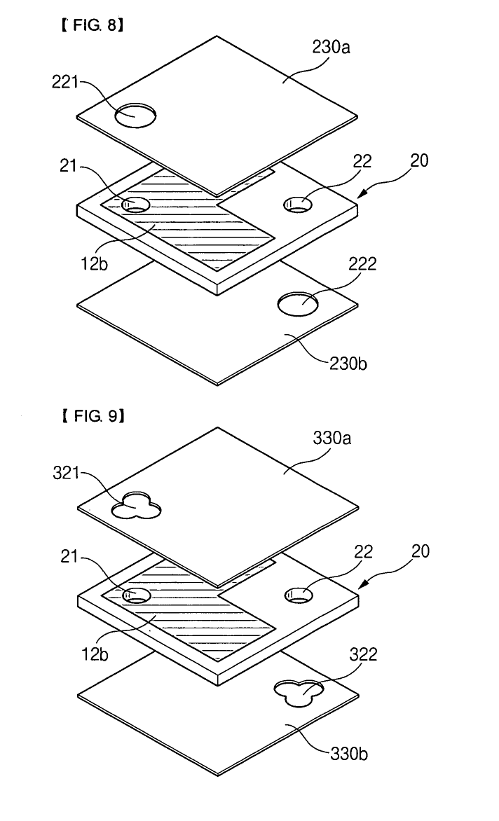

Next, a method of forming an external electrode by using only a via hole without any nickel layers being formed on the upper and lower portions of the multi-layer sheet product will be described with reference to FIGS. 8 to 10.

[Fifth Embodiment]

FIG. 8 is a diagram explaining a process of manufacturing a built-in type upper/lower electrode multi-layer part according to a fifth embodiment of the present invention.

Referring to FIG. 8, a shown multi-layer sheet product 20 is formed by the same process as in FIGS. 4A to 4C (or FIGS. 5A to 5C). On one corner of the multi-layer sheet product 20, a first via hole 22 is formed so as to connect first inner electrodes (not shown). On the other corner in the diagonal direction of the one corner, a second via hole 21 is formed so as to connect second inner electrodes (not shown).

On the upper and lower portions of the multi-layer sheet product 20, a plurality of ceramic sheets 230a and 230b are respectively laminated to have a desired thickness, in which the third and fourth via holes 221 and 222 are respectively formed.

The ceramic sheets 230a and 230b do not have any internal electrode pattern formed thereon. The size of the third and fourth via holes 221 and 222 are larger than that of the first and second via holes 22 and 21.

After the ceramic sheets 230a and 230b in which the third and fourth via holes 221 and 222 are formed are joined on the upper and lower portions of the multi-layer sheet product 20, a conductive paste is filled in the first and fourth via holes 22, 21, 221, and 222, and is then dried. Then, a chip having a desired shape is completely manufactured through a grinding process and a burning and plasticizing process.

In the built-in type upper/lower electrode multi-layer part manufactured in such a manner, the third and fourth via holes 221 and 222 formed on the upper and lower portions are larger than the first and second via holes 22 and 21. Therefore, the external electrodes can be formed by only the via holes, without nickel (Ni) layers being formed on the upper and lower portions of the multi-layer sheet product.

[Sixth Embodiment]

FIG. 9 is a diagram explaining a process of manufacturing a built-in type upper/lower electrode multi-layer part according to a sixth embodiment of the present invention.

In manufacturing the built-in type upper/lower electrode multi-layer part, punching or drilling is performed several times so that via holes 321 and 322 respectively formed on ceramic sheets 330a and 330b have a larger size than the first and second via holes formed on the multi-layer sheet product 20, as shown in FIG. 9.

Similar in FIG. 8, the external electrodes formed on the top and bottom surfaces are formed to have a larger area than the existing via holes. Therefore, the external electrodes can be formed by only the via holes, without nickel layers being formed on the top and bottom surfaces.

[Seventh Embodiment]

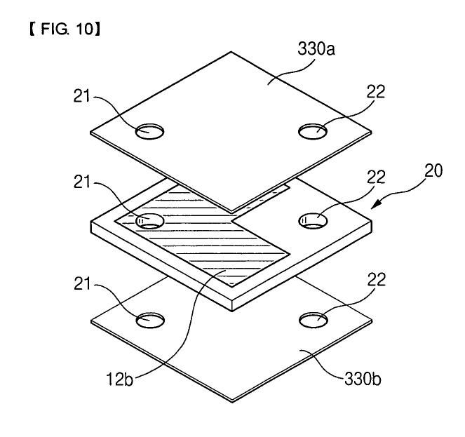

FIG. 10 is a diagram explaining a process of manufacturing a built-in type upper/lower electrode multi-layer part according to a seventh embodiment of the present invention.

Referring to FIG. 10, the shown multi-layer sheet product 20 is formed by the same process as in FIGS. 4A to 4C (or FIGS. 5A to 5C). In the diagonal corners of the multi-layer sheet product 20, the first via hole 22 for connecting the first internal electrode patterns (not shown) and the second via hole 21 for connecting the second internal electrode patterns (not shown) are respectively formed.

On the upper and lower portions of the multi-layer sheet product 20, the plurality of ceramic sheets 330a and 330b are respectively laminated to have a desired thickness, in which the first and second via holes 22 and 21 are formed. The ceramic sheets 330a and 330b do not have any internal electrode pattern formed thereon.

After the ceramic sheets 330a and 330b in which the first and second via holes 22 and 21 are formed are joined on the upper and lower portions of the multi-layer sheet product 20, a conductive paste is filled in the first and second via holes 22 and 21, and is then dried.

The built-in type upper/lower electrode multi-layer part manufactured in such a manner is provided with two external electrodes which are respectively formed on the upper and lower portions so as to connect the first and second internal electrode patterns. Therefore, when the built-in type upper/lower electrode multi-layer part is mounted inside a substrate, the via hole can be formed in only one direction, which makes it easy to form a via hole. In other words, in a conventional case where external electrodes are respectively formed on the upper and lower portions of a part, it is not difficult to form a via hole for connecting the upper electrode, but it is very difficult to form a via hole with the lower electrode formed on the lower portion of the part.

In the present invention, a multi-layer ceramic capacitor (MLCC) has been exemplified and described as a multi-layer part in which upper and lower external electrodes are formed. However, the present invention can be applied to all electronic parts using a multi-layer method.

While the present invention has been described with reference to exemplary embodiments thereof, it will be understood by those skilled in the art that various changes and modifications in form and detail may be made therein without departing from the scope of the present invention as defined by the following claims.

As described above, in the built-in type upper/lower electrode multi-layer part and the method of manufacturing the same according to the present invention, the following advantages can be achieved. The area where the internal electrode patterns of the plurality of laminated ceramic sheets overlap each other is formed to differ in accordance with an electrostatic capacity, to thereby realize a desired electrostatic capacity band.

Further, the plurality of first and second ceramic sheets having a different internal electrode pattern from each other are alternately laminated, and the first and second via holes for respectively connecting the first and second ceramic sheets are formed. Then, when the via holes are formed on the ceramic sheets which are respectively joined on the top and bottom surface of the multi-layer sheet product, the via holes are formed to have a larger size than the first and second via holes, which makes it possible for the external electrodes to be formed by only the via holes, without nickel layers being formed.

Since the external electrode of the built-in type upper/lower electrode multi-layer part is formed on the entire or predetermined portion of the upper and lower portions, it is easy to form a via hole on a substrate.

The built-in type upper/lower electrode multi-layer part is manufactured to have the same length and width. Accordingly, the number of punching or drilling processes can be reduced to one time, the punching or drilling being performed to build the part into a substrate. Further, the bending strength of the part can be enhanced.

The external electrode can be formed without an external electrode forming process which is regularly performed in manufacturing a conventional chip.

The upper and lower external electrodes are formed through a laminating or printing process, without an external electrode coating process being performed. Therefore, the electrodes can be built in a substrate by a simple and inexpensive method.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a built-in type upper/lower electrode multi-layer part comprising:
alternately laminating a first ceramic sheet having a first internal electrode pattern formed thereon and a second ceramic sheet having a second internal electrode pattern formed thereon so as to form a first multi-layer sheet product;
forming first and second via holes on the first multi-layer sheet product, the first and second via holes respectively connecting the first and second internal electrode patterns;
respectively joining third and fourth ceramic sheets having no internal electrode pattern on the upper and lower portions of the first multi-layer sheet product so as to form a second multi-layer sheet product, the third and fourth ceramic sheets having third and fourth via holes formed to correspond to the first and second via holes; and
filling a conductive paste in the first to fourth via holes.

2. The method of manufacturing a built-in type upper/lower electrode multi-layer part according to claim 1,
wherein the first and second ceramic sheets are formed in a square shape.

3. The method of manufacturing a built-in type upper/lower electrode multi-layer part according to claim 1,
wherein predetermined portions of the first and second internal electrode patterns overlap each other when the first and second ceramic sheets are laminated.

4. The method of manufacturing a built-in type upper/lower electrode multi-layer part according to claim 3,
wherein an area where the first and second internal electrode patterns overlap each other differs in accordance with an electrostatic capacity.

5. The method of manufacturing a built-in type upper/lower electrode multi-layer part according to claim 1,
wherein the size of the third and fourth via holes is the same as that of the first and second via holes.

6. The method of manufacturing a built-in type upper/lower electrode multi-layer part according to claim 1,
wherein the size of the third and fourth via holes is larger than that of the first and second via holes.

7. The method of manufacturing a built-in type upper/lower electrode multi-layer part according to claim 1 further including
respectively forming metal layers on the upper and lower portions of the second multi-layer sheet product in which the conductive paste is filled.

8. The method of manufacturing a built-in type upper/lower electrode multi-layer part according to claim 7,
wherein the metal layers are formed by joining metallic sheets.

9. The method of manufacturing a built-in type upper/lower electrode multi-layer part according to claim 7,
wherein the metal layers are formed at the same time when a conductive paste is filled in the first to fourth via holes.

10. The method of manufacturing a built-in type upper/lower electrode multi-layer part according to any one of claims 7 to 9,
wherein the metal layer is formed of nickel (Ni).

11. The method of manufacturing a built-in type upper/lower electrode multi-layer part according to claim 10,
wherein the metal layer is plated so as not to be oxidized by water.

12. A built-in type upper/lower electrode multi-layer part comprising:
a first ceramic sheet having a first internal electrode pattern formed thereon;
a second ceramic sheet having a second internal electrode pattern formed thereon;
a first multi-layer sheet product which is formed by alternately laminating the first and second ceramic sheets and in which first and second via holes are formed to respectively connect the first and second internal electrode patterns;
a second multi-layer sheet product in which third and fourth ceramic sheets having no internal electrode pattern are respectively joined on the upper and lower portions of the first multi-layer sheet product, the third and fourth ceramic sheets having third and fourth via holes formed to correspond to the first and second via holes; and
a conductive paste which is filled in the first to fourth via holes.

13. The built-in type upper/lower electrode multi-layer part according to claim 12,
wherein the first and second ceramic sheets are formed in a square shape.

14. The built-in type upper/lower electrode multi-layer part according to claim 12,
wherein predetermined portions of the first and second internal electrode patterns overlap each other when the first and second ceramic sheets are laminated.

15. The built-in type upper/lower electrode multi-layer part according to claim 14,
wherein the first internal electrode pattern is formed in a reverse L shape, and the second internal electrode pattern is formed in an L shape.

16. The built-in type upper/lower electrode multi-layer part according to claim 14,
wherein the first internal electrode pattern having a first hole formed on one side thereof is formed in a square shape, and the second internal electrode pattern having a second hole formed on one side thereof is formed in a square shape.

17. The built-in type upper/lower electrode multi-layer part according to claim 14,
wherein the first internal electrode pattern is formed in a reverse L shape or an L shape, and a predetermined portion of the second internal electrode pattern is overlapped with the first internal electrode pattern so as to realize a low capacity band.

18. The built-in type upper/lower electrode multi-layer part according to claim 14,
wherein the first internal electrode pattern having a first hole formed on one side thereof is formed in a square shape, and the second internal electrode pattern having a second hole formed on one side thereof is formed so that the overall internal electrode pattern is included in the first internal electrode pattern.

19. The built-in type upper/lower electrode multi-layer part according to claim 12,
wherein the third and fourth via holes have the same size as the first and second via holes.

20. The built-in type upper/lower electrode multi-layer part according to claim 12,
wherein the third and fourth via holes have a larger size than the first and second via holes.

21. The built-in type upper/lower electrode multi-layer part according to claim 12 further including
metal layers that are formed on the upper and lower portions of the second multi-layer sheet product in which the conductive paste is filled.

22. The built-in type upper/lower electrode multi-layer part according to claim 21,
wherein the metal layers are formed of a metallic sheet.

23. The built-in type upper/lower electrode multi-layer part according to claim 21,
wherein the metal layers are formed at the same time when the conductive paste is filled in the first to fourth via holes.

24. The built-in type upper/lower electrode multi-layer part according to any one of claims 21 to 23,
wherein the metal layers are plated so as not to be oxidized by water.
